(19) United States
(12) Patent Application Publication
(10) Pub. No.: US 2026/0118118 A1
(43) Pub. Date: Apr. 30, 2026

(54) ULTRASONIC METHOD AND SYSTEM FOR SIMULTANEOUSLY MEASURING COATING AND LUBRICATION FILM THICKNESSES

(71) Applicant: XI'AN JIAOTONG UNIVERSITY, Xi'an (CN)

(72) Inventors: Tonghai WU, Xi'an (CN); Yumin ZHANG, Xi'an (CN); Peng ZHENG, Xi'an (CN); Pan DOU, Xi'an (CN); Shijie WEI, Xi'an (CN)

(21) Appl. No.: 19/372,229

(22) Filed: Oct. 28, 2025

(30) Foreign Application Priority Data
Oct. 28, 2024 (CN) 202411511412.1

(51) Int. Cl. G01B 17/02

(52) U.S. Cl. CPC G01B 17/025

(57) ABSTRACT

An ultrasonic method for simultaneously measuring coating and lubrication film thicknesses, in which a pseudo-reflection coefficient is constructed based on an overall echo signal from a four-layer structure and a reference signal from a coating-air interface; an amplitude spectrum of the pseudo-reflection coefficient is obtained; if there is an extremum point in the amplitude spectrum of the pseudo-reflection coefficient, a pseudo-reflection coefficient corresponding to an ultrasonic frequency at the extremum point is extracted to obtain a coating thickness, and a first thickness of a lubrication film is obtained based on the frequency; otherwise, a pseudo-reflection coefficient corresponding to a frequency at a maximum of an amplitude spectrum of a reference signal is extracted to obtain a second thickness of the lubrication film; and based on the first or second thickness, a thickness h of the lubrication film in the four-layer structure is measured.

### CROSS-REFERENCE TO RELATED APPLICATIONS

This application claims the benefit of priority from Chinese Patent Application No. 202411511412.1, filed on Oct. 28, 2024. The content of the aforementioned application, including any intervening amendments thereto, is incorporated herein by reference in its entirety.

### TECHNICAL FIELD

This application relates to the detection of lubrication state of friction pair in machinery systems, and particularly to an ultrasonic method and system for simultaneously measuring coating and lubrication film thicknesses.

### BACKGROUND

In various practical engineering scenarios, it is common for relative movement components to simultaneously adopt lubricating fluids and coatings to provide superior lubrication performance and extended service life for equipment. In sliding bearings, in addition to the use of the lubricating fluids to reduce friction and wear, the coating is applied to the bearing surfaces to enhance self-lubricating performance and high-temperature resistance during start and stop stages. In key components of aircraft engines, such as pistons and cylinders, a combination of the lubricating fluids and the coatings is often adopted. The lubricating fluids provides continuous lubricating effect during high-speed operation, while the coating provides additional protection under extreme temperature and pressure conditions, preventing direct contact and wear between components. In a wind turbine transmission systems components such as gearboxes and drive shafts generate significant friction and heat during operation. To reduce the friction coefficient and minimize wear, the lubricating fluids are typically used for lubrication, while a layer of wear-resistant and high-temperature-resistant coating is applied to the surfaces of gears and shafts to improve the overall performance and reliability of the automotive transmission system. When mechanical equipment operates under extreme conditions such as high temperature and high pressure, a lubrication film is highly prone to break to lead to a mixed lubrication state, resulting in abnormal wear of the components. Therefore, measuring a lubrication film thickness of friction pair with a four-layer structure is crucial for monitoring the lubrication state of mechanical equipment and subsequently implementing predictive maintenance.

Focused on the measurement of the lubrication film thickness, the ultrasonic method, due to its non-destructive testing and compact sensor structure, has become one of the most promising dynamic measurement methods for the lubrication film thickness, and has begun to attract research attention in structures such as pistons and sliding bearings.

At present, focused on typical three-layer friction pair structure (solid-lubrication film-solid), the ultrasonic method has broken through the bottlenecks of continuous measurement and high-resolution measurement of the lubrication film thickness over a wide range. However, for the measurement of the lubrication film thickness of the four-layer structure (solid-coating-lubrication film-solid) including a thin coating, it remains a bottleneck that is difficult to break through.

Firstly, for the friction pair with the four-layer structure, due to a short time interval of reflected echoes at upper and lower interfaces of the thin coating waveform superposition often occurs, therefore, the reflected echoes cannot be separated. The method for calculating the lubrication film thickness using a three-layer structure model based on classical reflection coefficient (RC) will fail.

Secondly, the method for calculating the lubrication film thickness through approximately estimating a solid-coating interface reflection echo using reference echoes and Gaussian waves has a limited measurement range, and is only applicable to the measurement of lubrication film thickness less than 10 μm. Besides, such method ignores the influence of multiple reflection echoes in the coating, resulting in significant estimation errors.

Finally, based on a four-layer structure model of classic reflection coefficient (RC), the measurement of lubrication film thickness less than 100 μm can be realized. However, such method requires obtaining the coating thickness in advance and separating the incident signals. However, in engineering practices, it is difficult to accurately obtain the coating thickness, and the separation of the incident signals is highly dependent on the accuracy of the coating thickness. A slight measurement errors of the coating thickness will cause non-negligible measurement errors in the lubrication film thickness, resulting in poor stability of this method.

Therefore, how to accurately measure the coating thickness of the friction pair with the four-layer structure and the lubrication film thickness over the wide range is a research difficulty at present.

### SUMMARY

In view of the above deficiencies in the prior art, this application provides an ultrasonic method and system for simultaneously measuring coating and lubrication film thicknesses, so as to solve the technical problem in engineering practice of difficulty in measuring a coating thickness and the poor stability, weak anti-interference ability and small measurement range of the existing methods for measuring lubrication film thickness of a four-layer structure, and realize synchronous measurement of coating thickness of a friction pair with the four-layer structure and lubrication film thickness over a wide range.

Technical solutions of this application are described as follows.

An ultrasonic method for simultaneously measuring coating and lubrication film thicknesses of a friction pair in real time is provided, the friction pair having a four-layer structure consisting of a first solid layer, a coating, a lubrication film and a second solid layer from inside to outside, and the ultrasonic method comprising:
deploying an ultrasonic sensor at the first solid layer;
constructing a pseudo-reflection coefficient;
obtaining an amplitude spectrum of the pseudo-reflection coefficient;
if there is an extremum point in the amplitude spectrum of the pseudo-reflection coefficient, extracting a first pseudo-reflection coefficient information corresponding to an ultrasonic frequency at the extremum point to obtain a coating thickness d, and obtaining a first thickness h₁ of the lubrication film based on the frequency at the extremum point;
if there are extremum points in the amplitude spectrum of the pseudo-reflection coefficient, extracting a second pseudo-reflection coefficient information corresponding to an ultrasonic frequency at a maximum of an amplitude spectrum of a reference signal to obtain a second thickness h₂ of the lubrication film; and
based on the first thickness h₁ and the second thickness h₂, measuring a thickness h of the lubrication film over a range of the friction pair in real time.

In an embodiment, the step of constructing pseudo-reflection coefficient comprises:
before testing, removing a lubricating medium from the four-layer structure; emitting an ultrasonic wave to a solid-coating-air-solid structure; and collecting and storing a combination of an echo signal reflected from a coating-air interface and an echo signal reflected from a solid-coating interface as the reference signal R(f);
during the testing, injecting the lubricating medium into the solid-coating-air structure to form the lubrication film, so as to construct the four-layer structure; continuously emitting the ultrasonic wave to the four-layer structure; and collecting and storing a combination of an echo signal reflected from a solid-coating interface, an echo signal reflected from a coating-lubrication film interface and an echo signal reflected from a lubrication film-solid interface as an overall echo signal O(f);
performing fast Fourier transform (FFT) on the reference signal R(f) and the overall echo signal O(f) to obtain an amplitude spectrum and a phase spectrum of the reference signal R(f), and an amplitude spectrum and a phase spectrum of the overall echo signal O(f); constructing the pseudo-reflection coefficient V_{P}(f) based on the reference signal R(f) and the overall echo signal O(f); and obtaining an amplitude spectrum |V_{P}(f)| of the pseudo-reflection coefficient V_{P}(f) and a phase spectrum O_{V}_{_{P}}(f) of the pseudo-reflection coefficient V_{P}(f).

In an embodiment, the pseudo-reflection coefficient V_{P}(f) is expressed as:

$${V}_{P} ( f ) = \frac{O ( f )}{R ( f )} .$$

In an embodiment, the first thickness h₁ of the lubrication film is expressed as:

$${h}_{1} = \frac{{c}_{3}}{2 {f}_{r}} ;$$

wherein c₃ represents a sound velocity in the lubrication film; and fᵣ represents a first-order resonance frequency in the amplitude spectrum of the pseudo-reflection coefficient.

In an embodiment, the coating thickness d is expressed as:

$$\begin{matrix}d = \frac{{c}_{2}}{4 π {f}_{r}} Arg [ \begin{matrix}\frac{\begin{matrix}4 ( {T}_{R}^{6} {T}_{R}^{8} {V}_{P} ( {f}_{r} ) - {T}_{R}^{2} {T}_{R}^{4} ) ( {T}_{R}^{1} - {T}_{R}^{5} {T}_{R}^{7} {V}_{P} ( {f}_{r} ) ) + \\ {( {T}_{R}^{2} + {T}_{R}^{1} {T}_{R}^{4} - ( {T}_{R}^{6} {T}_{R}^{7} + {T}_{R}^{5} {T}_{R}^{8} ) {V}_{P} ( {f}_{r} ) )}^{2}\end{matrix}}{2 {T}_{R}^{2} {T}_{R}^{4} - 2 {T}_{R}^{6} {T}_{R}^{8} {V}_{P} ( {f}_{r} )} + \\ \frac{( {T}_{R}^{6} {T}_{R}^{7} + {T}_{R}^{5} {T}_{R}^{8} ) {V}_{P} ( {f}_{r} ) - {T}_{R}^{2} - {T}_{R}^{1} {T}_{R}^{4}}{2 {T}_{R}^{2} {T}_{R}^{4} - 2 {T}_{R}^{6} {T}_{R}^{8} {V}_{P} ( {f}_{r} )}\end{matrix} ] \\ \{ \begin{matrix}{T}_{R}^{1} = {z}_{1} {z}_{2} - {z}_{2}^{2} + {z}_{1} {z}_{4} - {z}_{2} {z}_{4} \\ {T}_{R}^{2} = {z}_{1} {z}_{2} + {z}_{2}^{2} - {z}_{1} {z}_{4} - {z}_{2} {z}_{4} \\ {T}_{R}^{3} = {z}_{1} {z}_{2} + {z}_{2}^{2} + {z}_{1} {z}_{a i r} + {z}_{2} {z}_{a i r} \\ {T}_{R}^{4} = {z}_{1} {z}_{2} - {z}_{2}^{2} - {z}_{1} {z}_{a i r} + {z}_{2} {z}_{a i r} \\ {T}_{R}^{5} = {z}_{1} {z}_{2} + {z}_{2}^{2} + {z}_{1} {z}_{4} + {z}_{2} {z}_{4} \\ {T}_{R}^{6} = {z}_{1} {z}_{2} - {z}_{2}^{2} - {z}_{1} {z}_{4} + {z}_{2} {z}_{4} \\ {T}_{R}^{7} = {z}_{1} {z}_{2} - {z}_{2}^{2} + {z}_{1} {z}_{a i r} - {z}_{2} {z}_{a i r} \\ {T}_{R}^{8} = {z}_{1} {z}_{2} + {z}_{2}^{2} - {z}_{1} {z}_{a i r} - {z}_{2} {z}_{a i r}\end{matrix}\end{matrix} ;$$

wherein V_{P}(fᵣ) represents a pseudo-reflection coefficient corresponding to an ultrasonic frequency fᵣ of the extremum point; z₁ represents an acoustic impedance of an i-th medium, wherein i=1, 2, 4; ρᵢ represents a density of the i-th medium; cᵢ represents a sound velocity in the i-th medium; zₐᵢᵣ represents an acoustic impedance of air; and

$${T}_{R}^{i}$$

represents a transform symbol, wherein i=1, 2, . . . , 8.

In an embodiment, the second thickness h₂ of the lubrication film is expressed as:

$${h}_{2} = \frac{{c}_{3}}{4 π {f}_{c}} arg [ \frac{( {z}_{3} + {z}_{4} ) ( {z}_{3} - {z}_{3}^{eqv} )}{( {z}_{3} - {z}_{4} ) ( {z}_{3} + {z}_{3}^{eqv} )} ] ;$$

wherein f_{c} represents the ultrasonic frequency at the maximum of the amplitude spectrum of the reference signal; z₃ represents an acoustic impedance of the lubrication film; z₄ represents an acoustic impedance of the the second solid layer; ρᵢ represents the density of the i-th medium; c₁ represents the sound velocity in the i-th medium;

$${z}_{i}^{e q v}$$

represents an equivalent impedance of the i-th medium in a solid-coating-lubrication film-solid structure.

In an embodiment,

$${z}_{3}^{e q v}$$

is expressed as:

$${z}_{3}^{e q v} = {z}_{2} \frac{{z}_{2}^{e q v} - {z}_{2} + ( {z}_{2}^{e q v} + {z}_{2} ) {e}^{i 2 {k}_{2} d}}{{z}_{2} - {z}_{2}^{e q v} + ( {z}_{2}^{e q v} + {z}_{2} ) {e}^{i 2 {k}_{2} d}} ;$$

wherein

$${z}_{2}^{e q v}$$

represents an equivalent impedance of the coating in the solid-coating-lubrication film-solid structure; z₂ represents an acoustic impedance of the coating; ρ₂ represents a density of the coating; c₂ represents a sound velocity in the coating; k₂ represents a wave number of the coating; and d represents the coating thickness.

In an embodiment, the equivalent impedance

$${z}_{{}^{2}}^{{}_{eqv}}$$

of the coating in the solid-coating-lubrication film-solid structure is expressed as:

$${z}_{2}^{e q v} = {z}_{1} \frac{{z}_{1} + {z}_{2}^{{eqv}^{{}_{′}}} + ( {z}_{2}^{{eqv}^{{}_{′}}} - {z}_{1} ) {V}_{P} ( {f}_{c} )}{{z}_{1} + {z}_{2}^{{eqv}^{{}_{′}}} - ( {z}_{2}^{{eqv}^{{}_{′}}} - {z}_{1} ) {V}_{P} ( {f}_{c} )} ;$$

wherein z₁ represents an acoustic impedance of the first solid layer; ρᵢ represents a density of the first solid layer; c₁ represents a sound velocity of the first solid layer;

$${z}_{2}^{{eqv}^{{}_{′}}}$$

represents an equivalent impedance of the coating in the solid-coating-air structure; and V_{P}(f_{c}) represents the pseudo-reflection coefficient corresponding to the ultrasonic frequency f_{c}.

In an embodiment,

$${z}_{2}^{eqv ′}$$

is expressed as:

$${z}_{2}^{eqv ′} = {z}_{2} = \frac{( {z}_{air}^{eqv} + {z}_{2} ) {e}^{- {ik}_{2} d} + ( {z}_{air}^{eqv} + {z}_{2} ) {e}^{{ik}_{2} d}}{( {z}_{air}^{eqv} + {z}_{2} ) {e}^{- {ik}_{2} d} - ( {z}_{air}^{eqv} + {z}_{2} ) {e}^{{ik}_{2} d}} ;$$

wherein

$${z}_{air}^{eqv}$$

represents an equivalent impedance of air in the solid-coating-air structure.

In a second aspect, an ultrasonic system for simultaneously measuring coating and lubrication film thicknesses of a friction pair is provided, the friction pair having a four-layer structure, and the ultrasonic system comprising:
a construction module;
a judgement module; and
a measurement module;
wherein the construction module is configured to construct a pseudo-reflection coefficient;
the judgement module is configured to perform:
   obtaining an amplitude spectrum of the pseudo-reflection coefficient; and
   determining whether there is an extremum point in the amplitude spectrum of
the pseudo-reflection coefficient; if yes, extracting a first pseudo-reflection coefficient information corresponding to an ultrasonic frequency at the extremum point to obtain a coating thickness d, and obtaining a first thickness h₁ of a lubrication film; otherwise, extracting a second pseudo-reflection coefficient information corresponding to an ultrasonic frequency at a maximum of an amplitude spectrum of a reference signal to obtain a second thickness h₂ of the lubrication film; and
the measurement module is configured to measure of a thickness h of the lubrication film over a range of the four-layer structure based on the first thickness h₁ and the second thickness h₂.

In a third aspect, a computer device is provided, comprising a memory, a processor, and a computer program stored in the memory and can be executed in the processor; and when the processor executes the computer program, the steps of the ultrasonic method for simultaneously measuring coating and lubrication film thicknesses above are realized.

In a fourth aspect, a computer-readable storage medium is provided, comprising a computer program; wherein the computer program is executed to realize the steps of the ultrasonic method for simultaneously measuring coating and lubrication film thicknesses above.

Compared to the prior art, this application has the following beneficial effects.

The ultrasonic method for simultaneously measuring coating and lubrication film thicknesses herein includes: based on a ratio of the overall echo signal obtained in the four-layer structure to the reference signal obtained in the coating-air interface, the pseudo-reflection coefficient (PRC) is obtained; the amplitude spectrum of the pseudo-reflection coefficient is obtained, and whether there is the extremum point in the amplitude spectrum of the pseudo-reflection coefficient is determined; if yes, the first pseudo-reflection coefficient information corresponding to the ultrasonic frequency at the extremum point is extracted to obtain the coating thickness d, and to obtain the first thickness h₁ of the lubrication film; otherwise, the second pseudo-reflection coefficient information corresponding to the ultrasonic frequency at the maximum of the amplitude spectrum of the reference signal is extracted to obtain the second thickness h₂ of the lubrication film; and based on the first thickness h₁ and the second thickness h₂, the third thickness h over the range of the friction pair is measured.

In an embodiment, the pseudo-reflection coefficient is constructed based on the overall echo signal obtained in the four-layer structure and the reference signal obtained in the coating-air interface, such process can effectively avoid a process of solving an incident signal in a classical reflection coefficient (RC) model, which fundamentally reduces an error propagation during a calculation process, and has better measurement accuracy and anti-interference ability.

In an embodiment, when the lubrication film thickness is relatively larger, the minimal value point occurs in the amplitude spectrum of the pseudo-reflection coefficient, and the first thickness h₁ is obtained based on the minimal value point, providing a basis for wide-range measurement of the third lubrication film thickness of the four-layer structure; at the same time, the coating thickness d is obtained based on the first pseudo-reflection coefficient information corresponding to the minimal value point, providing a basis for simultaneously ultrasonic measurement of coating and lubrication film thicknesses.

In an embodiment, when the lubrication film thickness is relatively smaller, the second pseudo-reflection coefficient information corresponding to the maximum of the amplitude spectrum of the reference signal is extracted to obtain the second thickness h₂, increasing a measurement range of the lubrication film thickness of the four-layer structure, and providing the basis for simultaneous measurement of coating and lubrication film thicknesses.

It can be understood that beneficial effects of the second aspect above can be referred to relevant descriptions of the first aspect, which are not elaborated herein.

In summary, the present disclosure utilizes the overall echo signal and the reference signal obtained by a sensor to construct the pseudo-reflection coefficient (PRC) without separating incident signals. The present disclosure decouples the lubrication film thickness and the coating thickness from the pseudo-reflection coefficient to accurately obtain the coating thickness, improving accuracy and stability of the measurement of the lubrication film thickness of the four-layer structure, which has important engineering significance for simultaneous and real-time measurement of coating and lubrication film thicknesses of the friction pair having the four-layer structure.

Technical solutions of the present disclosure will be further disclosed through the accompanying drawings and embodiments.

### BRIEF DESCRIPTION OF THE DRAWINGS

In order to illustrate the technical solutions of this application more clearly, the accompanying drawings required in the description of embodiments will be briefly introduced below. It is obvious that the following accompanying drawings only show some embodiments of this application, and for those of ordinary skill in the art, other relevant accompanying drawings can also be obtained according to these drawings without making creative effort.

FIG. 1 shows a signal processing flowchart for simultaneous measurement of coating and lubrication film thicknesses of friction pair having a four-layer structure according to an embodiment of the present disclosure.

FIG. 2a is a schematic diagram of ultrasonic propagation in a solid-coating-air structure according to an embodiment of the present disclosure.

FIG. 2b is a schematic diagram of ultrasonic propagation in a solid-coating-lubrication film-solid structure according to an embodiment of the present disclosure.

FIG. 3 shows an amplitude spectrum |V_{P}(f)| of a pseudo-reflection coefficient changed as a function of f·h according to an embodiment of the present disclosure.

FIG. 4 is a distribution diagram of measurement points on a sliding bearing with a coating in an aviation fuel gear pump according to an embodiment of the present disclosure.

FIG. 5 shows the amplitude spectrum of the pseudo-reflection coefficient at three measurement points under conditions of a rotational speed of 1000 rpm and a discharge pressure of 1.5 MPa according to an embodiment of the present disclosure.

FIG. 6 shows a measurement result of a coating thickness based on an ultrasonic pseudo-reflection coefficient method according to an embodiment of the present disclosure.

FIG. 7 shows a measurement result of the coating thickness based on an optical microscope method according to an embodiment of the present disclosure.

FIG. 8a shows a comparison result between measurement results and theoretical solutions of lubrication film thicknesses at different rotational speeds and at a room temperature according to an embodiment of the present disclosure.

FIG. 8b shows a comparison result between measurement results and theoretical solutions of lubrication film thicknesses at different discharge pressures and at the room temperature according to an embodiment of the present disclosure.

FIG. 9 is schematic diagram of a computer device according to Embodiment I of the present disclosure.

FIG. 10 is a block diagram of an electronic device according to Embodiment I of the present disclosure.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

It should be noted that in the description of the present disclosure, the terms “include” and “contain” indicate the presence of described features, entities, steps, operations, elements, and/or components, but do not exclude presence or addition of one or more other features, entities, steps, operations, elements, components, and/or a combination thereof.

It should be understood that the terms used herein are only for illustrating specific embodiments, which are not intended to limit the present disclosure. Unless otherwise defined, the terms that described in a singular form can be intended to include a plural form.

It should be understood that the term “and/or” used herein includes three solutions, for example, “A” and/or “B” includes solution “A”, solution “B”, and a combination thereof. Besides, the term “A/B” indicates A or B.

It should be understood that though the terms, such as “first”, “second” and “third”, used in embodiments of the present disclosure are for describing preset scopes, but not be intended to limit the preset scopes. These terms are only for distinguishing the preset scopes. For example, without departing from the scope of the embodiments of the present disclosure, a first preset scope can be referred to as a second preset scope, and similarly, the second preset scope can be referred to as the preset scope.

Depending on the context, the term “if” used herein can be interpreted as “at the time of”, “when”, “in response to determination” or “in response to detection”. Similarly, depending on the context, the term “if determined” can be interpreted as “when determining” or “in response to determination”; and the term “if detected (stated conditions or events)” can be interpreted as “when detecting (stated conditions or events)” or “in response to detection of (stated conditions or events)”.

The accompanying drawings illustrate schematic structural diagrams of embodiments according to the present disclosure. These drawings are not drawn to scale, where some details are enlarged for clarity while others details may be omitted for simplicity. Shapes of regions, layers, and their relative sizes and positions shown in the accompanying drawings are only illustrative, which may cause deviations due to manufacturing tolerances or technical limitations, and regions/layers with different shapes, sizes, and relative positions can be designed by those skilled in the art based on actual needs.

The present disclosure provides an ultrasonic method for simultaneously measuring coating and lubrication film thicknesses of a friction pair. The ultrasonic method includes: based on an overall echo signal obtained in a four-layer structure and reference signal obtained in a coating-air interface, a pseudo-reflection coefficient (PRC) is obtained; an amplitude spectrum of the pseudo-reflection coefficient is obtained, and whether there is an extremum point in the amplitude spectrum of the pseudo-reflection coefficient or not is determined; if yes, a first pseudo-reflection coefficient information corresponding to an ultrasonic frequency at the extremum point is extracted to obtain a thickness d, and to obtain a first thickness h₁ of a lubrication film; otherwise, a second pseudo-reflection coefficient information corresponding to an ultrasonic frequency at a maximum of the amplitude spectrum of the reference signal is extracted to obtain a second thickness h₂ of the lubrication film; based on the first thickness h₁ and the second thickness h₂, a third thickness h of the lubrication film over a range of the four-layer structure is measured. Compared with a traditional reflection coefficient (RC) model, the present disclosure does not require separation of incident signals, reduces an error propagation during a calculation process, has better reliability and measurement accuracy, and can realize the simultaneous measurement of coating and lubrication film thicknesses.

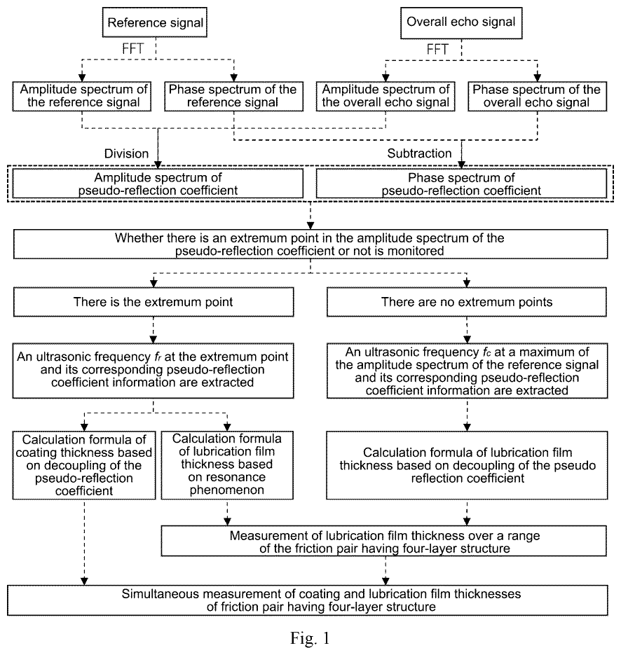

Referring to FIG. 1, an ultrasonic method for simultaneously measuring coating and lubrication film thicknesses of a friction pair in real time is provided, where the friction pair having a four-layer structure consisting of a first solid layer, a coating, a lubrication film and a second solid layer from inside to outside. The ultrasonic method includes the following steps.

(S1) An ultrasonic sensor at the first solid layer is deployed. A pseudo-reflection coefficient is constructed.

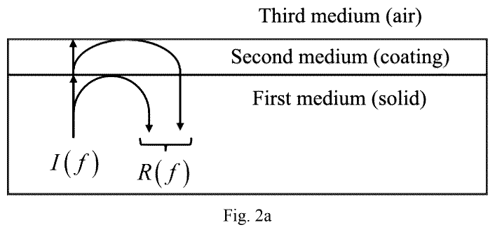

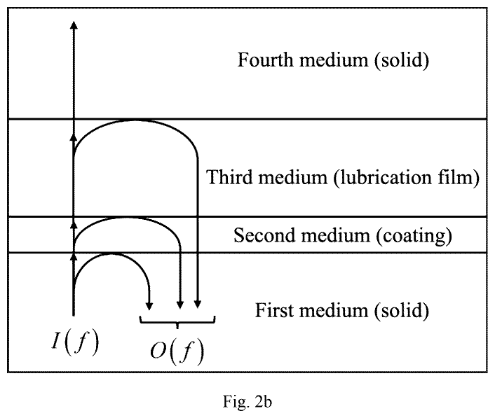

FIG. 2b is a is a schematic diagram of ultrasonic propagation in friction pair having a four-layer structure. In this frequency domain, I(f) represents an incident signal; in a solid-coating-air structure, a reference signal R(f) represents a combination of an echo signal reflected from a coating-air interface and an echo signal reflected from a solid-coating interface, and in a solid-coating-lubrication film-solid structure, an overall echo signal O(f) represents a combination of an echo signal reflected from a coating-lubrication film interface, an echo signal reflected from a coating-lubrication film interface and an echo signal reflected from a lubrication film-solid interface; Fast Fourier transform (FFT) is performed on the reference signal R(f) and the overall echo signal O(f) to obtain an amplitude spectrum and a phase spectrum of the reference signal R(f), and an amplitude spectrum and a phase spectrum of the overall echo signal O(f). The pseudo-reflection coefficient V_{P}(f) is constructed based on the reference signal R(f) and the overall echo signal O(f). An amplitude spectrum |V_{P}(f)| of the pseudo-reflection coefficient V_{P}(f) and a phase spectrum <_{P}(f) of the pseudo-reflection coefficient V_{P}(f) are obtained.

The pseudo-reflection coefficient V_{P}(f) is expressed:

$${V}_{P} ( f ) = \frac{O ( f )}{R ( f )} .$$

(S2) A first thickness h₁ of a lubrication film and a coating thickness d are measured.

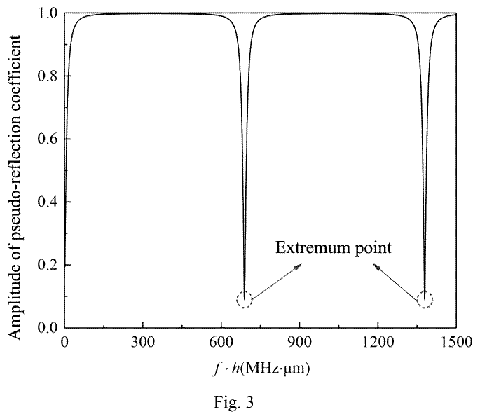

FIG. 3 shows the amplitude spectrum |V_{P}(f)| of the pseudo-reflection coefficient changed as a function of f·h. As a lubrication film thickness gradually increases, a minimal value point occurs in the amplitude spectrum |V_{P}(f)| of the pseudo-reflection coefficient. Based on the minimal value point in the amplitude spectrum |V_{P}(f)| of the pseudo-reflection coefficient, the first thickness h₁ of the lubrication film is calculated according to a frequency of the minimal value point, and the first thickness h₁ of the lubrication film is expressed as:

$${h}_{1} = \frac{{c}_{3}}{2 {f}_{r}} ;$$

where c₃ represents a sound velocity in the lubrication film; and fᵣ represents a first-order resonance frequency in the amplitude spectrum of the pseudo-reflection coefficient.

The coating thickness d is expressed as:

$$d = \frac{{c}_{2}}{4 π {f}_{r}} Arg [ \frac{\sqrt{4 ( {T}_{R}^{6} {T}_{R}^{8} {V}_{P} ( {f}_{r} ) - {T}_{R}^{2} {T}_{R}^{4} ) ( {T}_{R}^{1} - {T}_{R}^{5} {T}_{R}^{7} {V}_{P} ( {f}_{r} ) ) + {( {T}_{R}^{2} + {T}_{R}^{1} {T}_{R}^{4} - ( {T}_{R}^{6} {T}_{R}^{7} + {T}_{R}^{5} {T}_{R}^{8} ) {V}_{P} ( {f}_{r} ) )}^{2}}}{2 {T}_{R}^{2} {T}_{R}^{4} - 2 {T}_{R}^{6} {T}_{R}^{8} {V}_{P} ( {f}_{r} )} + \frac{( {T}_{R}^{6} {T}_{R}^{8} + {T}_{R}^{5} {T}_{R}^{8} ) {V}_{P} ( {f}_{r} ) - {T}_{R}^{2} - {T}_{R}^{1} {T}_{R}^{4}}{2 {T}_{R}^{2} {T}_{R}^{4} - 2 {T}_{R}^{6} {T}_{R}^{8} {V}_{P} ( {f}_{r} )} ]$$

$$\{ \begin{matrix}{T}_{R}^{1} = {z}_{1} {z}_{2} - {z}_{2}^{2} + {z}_{1} {z}_{4} - {z}_{2} {z}_{4} \\ {T}_{R}^{2} = {z}_{1} {z}_{2} + {z}_{2}^{2} - {z}_{1} {z}_{4} - {z}_{2} {z}_{4} \\ {T}_{R}^{3} = {z}_{1} {z}_{2} + {z}_{2}^{2} + {z}_{1} {z}_{air} + {z}_{2} {z}_{air} \\ {T}_{R}^{4} = {z}_{1} {z}_{2} - {z}_{2}^{2} - {z}_{1} {z}_{air} + {z}_{2} {z}_{air} \\ {T}_{R}^{5} = {z}_{1} {z}_{2} + {z}_{2}^{2} + {z}_{1} {z}_{4} + {z}_{2} {z}_{4} \\ {T}_{R}^{6} = {z}_{1} {z}_{2} - {z}_{2}^{2} - {z}_{1} {z}_{4} + {z}_{2} {z}_{4} \\ {T}_{R}^{7} = {z}_{1} {z}_{2} - {z}_{2}^{2} + {z}_{1} {z}_{air} - {z}_{2} {z}_{air} \\ {T}_{R}^{8} = {z}_{1} {z}_{2} + {z}_{2}^{2} - {z}_{1} {z}_{air} - {z}_{2} {z}_{air}\end{matrix} ;$$

where V_{P}(fᵣ) represents a pseudo-reflection coefficient corresponding to an ultrasonic frequency fᵣ of the extremum point; zᵢ=ρᵢcᵢ (i=1, 2, 4), and zᵢ represents an acoustic impedance of an i-th medium; ρᵢ represents a density of the i-th medium; cᵢ represents a sound velocity in the i-th medium; zₐᵢᵣ=ρₐᵢᵣcₐᵢᵣ, and zₐᵢᵣ represents an acoustic impedance of an air; ρₐᵢᵣ represents a density of the air; cₐᵢᵣ represents a sound velocity of air; and TR represents a transform symbol, where

$${T}_{R}^{i}$$

(S3) A second thickness h₂ of the lubrication film is measured.

If there are no minimal value point in the amplitude spectrum of the pseudo-reflection coefficient, a second pseudo-reflection coefficient information corresponding to an ultrasonic frequency at a maximum of an amplitude spectrum of a reference signal is extracted, and based on the coating thickness d, the second thickness h₂ is expressed as:

$${z}_{2}^{eqv} = \frac{{z}_{1} + {z}_{2}^{eqv ′} + ( {z}_{2}^{eqv ′} - {z}_{1} ) {V}_{P} ( {f}_{c} )}{{z}_{1} + {z}_{2}^{eqv ′} - ( {z}_{2}^{eqv ′} - {z}_{1} ) {V}_{P} ( {f}_{c} )} ;$$

$${z}_{3}^{eqv} = {z}_{2} \frac{{z}_{2}^{eqv} - {z}_{2} + ( {z}_{2}^{eqv} + {z}_{2} ) {e}^{i 2 {k}_{2} d}}{{z}_{2} - {z}_{2}^{eqv} + ( {z}_{2}^{eqv} + {z}_{2} ) {e}^{i 2 {k}_{2} d}} ; and$$

$${h}_{2} = \frac{{c}_{3}}{4 π {f}_{c}} arg [ \frac{( {z}_{3} + {z}_{4} ) ( {z}_{3} - {z}_{3}^{eqv} )}{( {z}_{3} - {z}_{4} ) ( {z}_{3} + {z}_{3}^{eqv} )} ]$$

where f_{c} represents the ultrasonic frequency of the maximum of the amplitude spectrum of the reference signal; V_{P}(f_{c}) represents a pseudo-reflection coefficient corresponding to the ultrasonic frequency f_{c}; zᵢ=ρᵢcᵢ; z₃ represents an acoustic impedance of the lubrication film; z₄ represents an acoustic impedance of the second solid layer; ρᵢ represents the density of the i-th medium; cᵢ represents the sound velocity in the i-th medium;

$${z}_{i}^{eqv}$$

represents an equivalent impedance of the i-th medium in the solid-coating-lubrication film-solid structure; z₁=ρ₁c₁, and z₁ represents an acoustic impedance of a first solid layer; ρ₁ represents a density of the first solid layer; c₁ represents a sound velocity of the first solid layer;

$${z}_{2}^{eqv ′}$$

represents an equivalent impedance of the coating in the solid-coating-lubrication film-solid structure; z₂=ρ₂c₂, and z₂ represents an acoustic impedance of the coating; ρ₂ represents a density of the coating; c₂ represents a sound velocity of the coating; k₂=2πf/c₂, and k₂ represents a wave number of the coating; and

$${z}_{2}^{eqv ′}$$

represents an equivalent impedance of the coating in the solid-coating-air structure.

The equivalent impedance

$${z}_{2}^{eqv ′}$$

of the coating in the solid-coating-air structure is expressed as:

$${z}_{2}^{eqv ′} = {z}_{2} = \frac{( {z}_{air}^{eqv} + {z}_{2} ) {e}^{- {ik}_{2} d} + ( {z}_{air}^{eqv} + {z}_{2} ) {e}^{{ik}_{2} d}}{( {z}_{air}^{eqv} + {z}_{2} ) {e}^{- {ik}_{2} d} - ( {z}_{air}^{eqv} + {z}_{2} ) {e}^{{ik}_{2} d}} ;$$

where

$${z}_{air}^{eqv}$$

represents an equivalent impedance of the air in the solid-coating-air structure, and is expressed as:

$${z}_{air}^{eqv} = {z}_{air}$$

(S4) The coating and lubrication film thicknesses in the friction pair having the four-layer structure are simultaneously measured.

Based on the first thickness h₁ obtained in step (S2) and the second thickness h₂ obtained in step (S3), a thickness h of the lubrication film over a range of the four-layer structure is measured, and then based on the thickness h of the lubrication film and the coating thickness d obtained in step (S2), the coating and lubrication film thicknesses in the friction pair having the four-layer structure are simultaneously measured.

If the real-time measured coating thickness and/or the real-time measured lubrication film thickness is lower than a corresponding preset thickness threshold, an early warning is issued, and the user will perform predictive maintenance on the machine. The measured film thickness results can be used to characterize the lubrication status of the equipment.

It can be understood by those skilled in the art that aspects of the present disclosure can be implemented as a system, method, or a program product. Therefore, the aspects of the present disclosure can be implemented can be implemented in the following forms: complete hardware, complete software including firmware and microcode, or a combination of hardware and software, which may collectively be referred to herein as a “circuit”, a “module” or a “platform”.

In another embodiment, an ultrasonic system for simultaneously measuring coating and lubrication film thicknesses of a friction pair is provided to implement the ultrasonic method above. The ultrasonic system includes a construction module, a judgement module and a measurement module.

In an embodiment, the construction module is configured to construct a pseudo-reflection coefficient.

The judgement module is configured to perform:
obtaining an amplitude spectrum of the pseudo-reflection coefficient; if there is an extremum point in the amplitude spectrum of the pseudo-reflection coefficient, the judgement module is configured to extract a first pseudo-reflection coefficient information corresponding to a frequency of the extremum point to obtain a coating thickness d, and to obtain a first thickness h₁ of a lubrication film; otherwise, the judgement module is configured to extract a second pseudo-reflection coefficient information corresponding to an ultrasonic frequency at a maximum of an amplitude spectrum of a reference signal to obtain a second thickness h₂ of the lubrication film.

The measurement module is configured to measure a thickness h of the lubrication film over a range of the friction pair based on the first thickness h₁ of the lubrication film and the second thickness h₂ of the lubrication film.

In another embodiment, the present disclosure provides a terminal device. The terminal device includes a processor and a memory. The memory is configured to store a computer program including a program instruction. The processor is configured to execute the program instruction stored in a computer-readable storage medium. The processor is selected from a central processing unit (CPU), a general-purpose processor, a digital signal processor (DSP), a field-programmable gate array (FPGA), and a programmable logic device including a discrete gate or transistor logic device and a discrete hardware component. The processor is a computational and control core of the terminal device, which is adapted to implement one or more instructions, specifically, the processor is adapted to load and execute one or more instructions to realize corresponding method steps or corresponding functions. The processor of the present disclosure is configured to perform an ultrasonic method for simultaneously measuring coating and lubrication film thicknesses including the following steps.

A pseudo-reflection coefficient is constructed. An amplitude spectrum of the pseudo-reflection coefficient is obtained. If there is an extremum point of the amplitude spectrum of the pseudo-reflection coefficient, a first pseudo-reflection coefficient information corresponding to a frequency at the extremum point is extracted to obtain a thickness d, and to obtain a first thickness h₁ of a lubrication film. Otherwise, a second pseudo-reflection coefficient information corresponding to an ultrasonic frequency at a maximum of the amplitude spectrum of the reference signal is extracted to obtain a second thickness h₂ of the lubrication film. Based on the first thickness h₁ and the second thickness h₂, a third thickness h of the lubrication film over a range of the friction pair is measured.

In another embodiment, the present disclosure further provides a storage medium, specifically a computer-readable storage medium also called memory. The computer-readable storage medium is a memory device in a terminal device, which is configured to store a program and data. It can be understood that the computer-readable storage medium herein includes a built-in storage medium in the terminal device, an expandable storage medium supported by the terminal device, and any tangible medium that contains or stores a program, where the program is configured to be used by an instruction execution system, apparatus, device or a combination thereof. The computer-readable storage medium provides storage space for an operation system of the terminal device. In addition, the storage space further stores one or more instructions adapted to be loaded and executed by the processor, such instructions can be one or more computer programs (including program codes). It should be noted that specific examples (a non-exhaustive list) of the computer-readable storage medium herein include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device and a combination thereof.

The computer-readable storage medium further includes a data signal propagated in a baseband or as a part of a carrier wave, which carries readable program codes. Such data signal propagates in various forms including but not limited to an electromagnetic signal, an optical signal and a combination thereof. The computer-readable storage medium can also be any other readable medium, and the readable medium is configured to send, propagate, or transmit a program configured to be used by an instruction execution system, apparatus, device or a combination thereof. A program code contained on the readable medium can be transmitted via any suitable medium, including but not limited to wireless, wireline, optical fiber cable, radio frequency (RF) and a combination thereof.

A program code for performing operations of the present disclosure can be written by one or more programming languages or a combination thereof. The programming languages include object-oriented programming languages, such as Java and C++, and conventional procedural programming languages, such as “C” programming language or similar programming languages. The program code can be executed completely on a user's computer, partly on the user's computer, as an independent software package, partly on the user's computer and partly on a remote computer, or completely on the remote computer or server. In response to a case that the remote computer is involved, the remote computer can be connected with the user's computer via any network including local area network (LAN) and a wide area network (WAN), or the remote computer can be connected with an external computer, for example, via the Internet using an Internet service provider.

The one or more instructions stored in the computer-readable storage medium can be loaded and executed by the processor, so as to realize corresponding steps of the ultrasonic method for simultaneously measuring coating and lubrication film thicknesses in the above embodiments. The one or more instructions stored in the computer-readable storage medium can be loaded and executed by the processor to perform the following steps.

A pseudo-reflection coefficient is constructed. An amplitude spectrum of the pseudo-reflection coefficient is obtained. If there is an extremum point of the amplitude spectrum of the pseudo-reflection coefficient, a first pseudo-reflection coefficient information corresponding to a frequency at the extremum point is extracted to obtain a thickness d, and to obtain a first thickness h₁ of a lubrication film. Otherwise, a second pseudo-reflection coefficient information corresponding to an ultrasonic frequency at a maximum of the amplitude spectrum of the reference signal is extracted to obtain a second thickness h₂ of the lubrication film. Based on the first thickness h₁ and the second thickness h₂, a thickness h of the lubrication film over a range of the friction pair is measured.

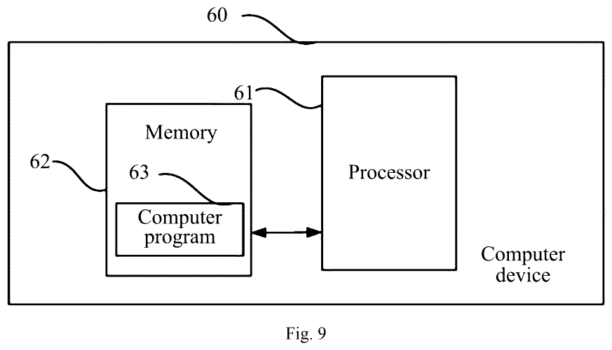

Referring to FIG. 9, the terminal device is a computer device, the computer device 60 in this embodiment includes a processor 61, a memory 62, and a computer program 63 stored in the memory 62 and can be executed in the processor 61. When the processor 61 executes the computer program 63, the ultrasonic method for simultaneously measuring coating and lubrication film thicknesses in this embodiment is realized which is not elaborated herein for simplicity. Or when the processor 61 executes the computer program 63, functions of each model/unit of the ultrasonic system for simultaneously measuring coating and lubrication film thicknesses are realized which are not elaborated herein for simplicity.

The computer device 60 can be a desktop computer, a laptop, a handheld computer, a cloud server, or other computing equipment. The computer device 60 include but not limited to the processor 61 and the memory 62. It can be understood by those skilled in the art that FIG. 9 is a schematic diagram of the computer device 60 which is not intended to limit the computer device 60, and FIG. 9 can include more or fewer components than those illustrated, some combined components or other different components, for example, the computer device 60 can further include a input/output device, a network access device and a bus.

The processor 61 is selected from a central processing unit (CPU), a general-purpose processor, a central processor, a graphics processor, a digital signal processor (DSP), an application specific integrated circuit, a field-programmable gate array (FPGA), and a programmable logic device including a discrete gate or transistor logic device, a data processing logic device based on quantum computing and a discrete hardware component. The general-purpose processor can be a microprocessor or any conventional processor.

The memory 62 can be an internal storage unit of the computer device 60, such as a hard disk or an internal storage of the computer device 60. The memory 62 can also be an external storage device of the computer device 60, such as a plug-in hard disk, a smart media card (SMC), a secure digital (SD) card, and a flash card.

In an embodiment, the memory 62 can include the internal storage unit of the computer device 60 and the external storage device. The memory 62 is configured to store the computer program and other programs and data required by the computer device. The memory 62 is also configured to temporarily storing data that has been output or is to be output.

The memory, database, or other medium in the embodiments in the present disclosure include a non-volatile memory, a volatile memory and a combination thereof. The non-volatile memory includes a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), and a graphene memory. The volatile memory includes a random access memory (RAM) and an external buffer memory. For illustrative rather than limitation, RAM is in various forms including a static random access memory (SRAM) and a dynamic random access memory (DRAM).

The database in the embodiments of the present disclosure includes a relational database, a non-relational database and a combination thereof. The non-relational database includes but not limited to a blockchain-based distributed database. The processor in the embodiments of the present disclosure includes but not limited to the general-purpose processor, the central processor, the graphics processor, the DSP, the programmable logic device and the data processing logic device based on quantum computing.

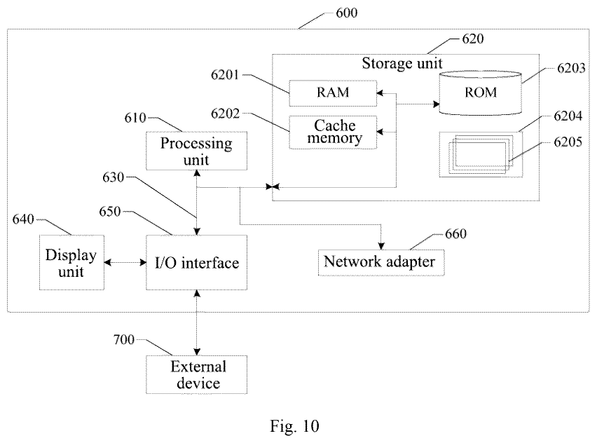

Referring to FIG. 10, the terminal device is an electronic device 600, which is in a form of a general-purpose computing device. The electronic device includes but note limited to at least one processing unit 610, at least one storage unit 620, a bus 630 for connecting different platform components (including the at least one storage unit 620 and the at least one processing unit 610), and a display unit 640.

In an embodiment, the storage unit stores the program code. The program code can be executed by the at least one processing unit 610, so that the at least one processing unit 610 executes steps in the embodiments corresponding to the above ultrasonic method. For example, the at least one processing unit 610 can execute steps shown in FIG. 1.

The at least one storage unit 620 includes a readable medium in a form of volatile memory, such as random access memory (RAM) 6201 and/or cache memory 6202. In an embodiment, the at least one storage unit 620 includes a read-only memory (ROM) 6203.

The at least one storage unit 620 further includes a program/utility 6204 including a set (at least one) of program modules 6205. Such program module 6205 include but not limited to an operation system, one or more application programs, other program modules, and program data. Each of these examples or some combination thereof may include an implementation of a network environment.

The bus 630 represents one or more types of bus structures, including a memory unit bus, a memory unit controller, a peripheral bus, an accelerated graphics port, a processing unit, or r a local bus that uses any of the types of bus structures.

The electronic device 600 is communicated with one or more external devices 700 including a keyboard, a pointing device, and a Bluetooth device. The electronic device 600 is also communicated with one or more devices that enable a user to interact with the electronic device 600, and/or one or more devices that enable the electronic device 600 to communicate with other computing devices (such as a router and a modem) that enable the electronic device 600 to communicate with one or more other computing devices, where communication therebetween can be realize through an input/output (I/O) interface 650. In addition, the electronic device 600 is communicated with one or more network, such as a local area network (LAN), a wide area network (WAN), and/or a public network including the Internet, via a network adapter 660. The network adapter 660 is communicated with other communication module of the electronic device 600 through the bus 630. It should be noted that other hardware and/or software modules can be used based on the electronic device 600 though not shown in the figure, and the hardware and/or software include but not limited to a microcode, a device driver, a redundant processing unit, an external disk drive array, a redundant array of independent disk (RAID) system, a tape drive a data backup storage platform.

To make the objects, technical solutions and advantages of the present disclosure more clearly, the technical solutions of the present disclosure will be clearly and completely described below with reference to the accompanying drawings. It is obviously that described herein are only some embodiments of the present disclosure, rather than all embodiments. The components described in the accompanying drawings and shown in the embodiments of the present disclosure can be arranged and designed in various different configurations. Therefore, detailed description of the embodiments of the present disclosure is not intended to limit the scope of this application defined by the appended claims, but merely represents selected embodiments of the present disclosure. Based on the embodiments of the present disclosure, other embodiments obtained by those of ordinary skill in the art without making creative effort shall fall within the scope of the present disclosure.

### EMBODIMENTS

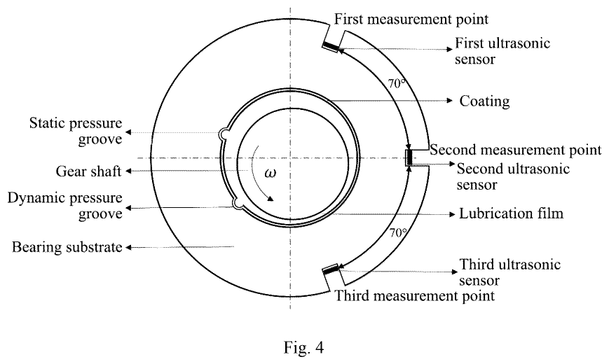

Dynamic tests are conducted on an aviation fuel gear pump to verified the effectiveness of the ultrasonic method. FIG. 4 is a distribution diagram of measurement points on a sliding bearing with a coating in the aviation fuel gear pump, and selection of measurement points of a thickness of a lubrication film follows principles of measuring the lubrication film thickness in a main load-bearing zone to the greatest extent possible while also obtaining a circumferential distribution of the lubrication film thickness, specifically, three measurement points of the lubrication film thickness are set on an active sliding bearing, and each of the three measurement points is provided with a first ultrasonic sensor 1, a second ultrasonic sensor 2 and a third ultrasonic sensor 3, where a first measurement point in the three measurement points is located in the main load-bearing zone, and a second measurement point in the three measurement points and a third measurement point in the three measurement points are configured to obtain the circumferential distribution of the lubrication film thickness.

An experimental system primarily includes the aviation fuel gear pump, a hydraulic control system, a data acquisition system, and a lubrication film thickness ultrasonic measurement system. A rotational speed of the aviation fuel gear pump is adjusted by a motor. An inlet pressure and a discharge pressure are controlled by an overflow valve, and the inlet pressure is fixed at approximately 0.5 MPa. The lubrication film thickness ultrasonic measurement system is an FMS-100 system manufactured by Tribosonics Ltd., UK, which integrates an ultrasonic pulser-receiver, a data acquisition card, and a computer. Such system emits a pulse at a repetition frequency of 20 kHz to excite an ultrasonic sensor to generate an ultrasonic wave, and collects an ultrasonic echo at a sampling frequency of 100 MHz, following by uploading the ultrasonic echo to the computer for processing.

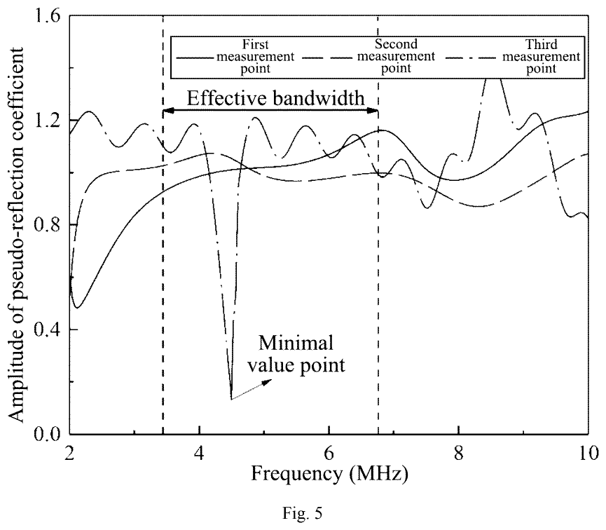

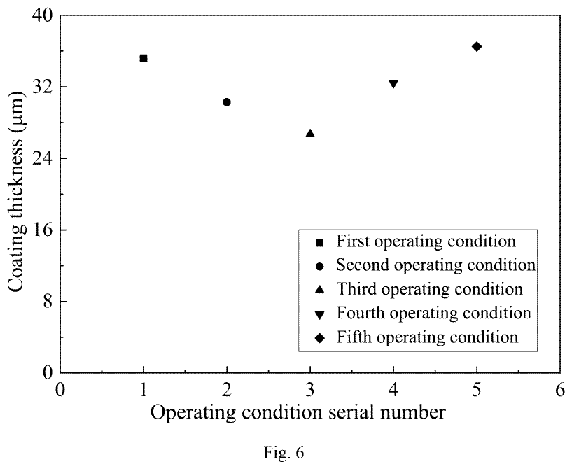

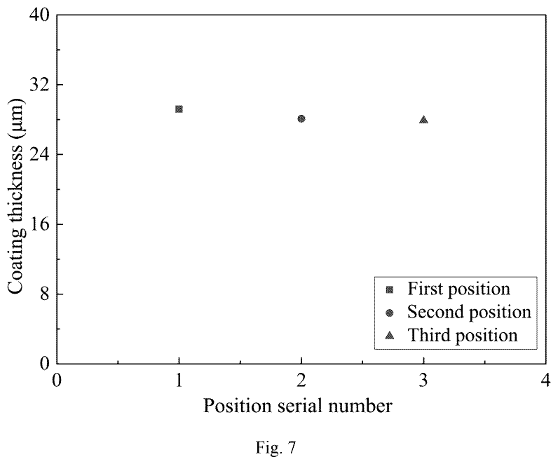

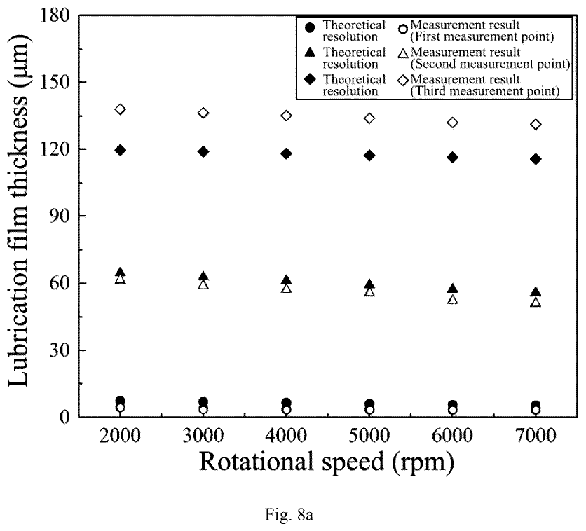

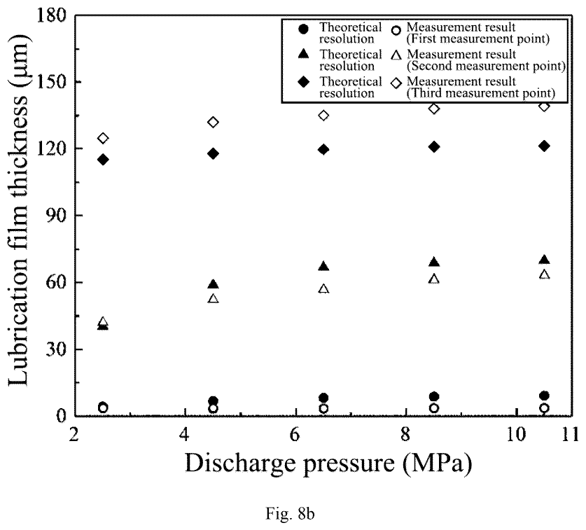

FIG. 1 shows a signal processing flowchart for simultaneous measurement of coating and lubrication film thicknesses of friction pair having the four-layer structure. An ultrasonic signal is processed according to the signal processing flowchart, so as to calculate the coating and lubrication film thicknesses. Referring to FIG. 5, under conditions of room temperature, 1000 rpm of the rotational speed and 1.5 MPa of the discharge pressure, an amplitude spectrum of a pseudo-reflection coefficient of each of the three measurement points are observed, and only a minimal value point occurs in the amplitude spectrum of the pseudo-reflection coefficient of the third measurement point. Therefore, a signal of the third point is extracted to analyze and calculate the coating thickness. Referring to FIG. 6, based on the coating thickness measured by the ultrasonic method, 5 operating conditions are selected, and 10 ultrasonic echo signals are extracted and calculated for each condition, and results are averaged. To verify the accuracy of the measurement results of the coating thickness, a cross-section of the bearing is obtained via mechanical processing, and the coating thicknesses at three locations on the cross-section are observed and measured by an optical microscope. FIG. 7 shows the measurement result of the coating thickness based on an optical microscope method. An average value of the coating thickness measurements based on the ultrasonic pseudo-reflection coefficient method is taken as the result of the ultrasonic method, the average value of the measurements at the three locations obtained by optical microscopy is taken as the result of the optical method. The result of the ultrasonic method and the result of the optical method are compared, showing a relative error of only 13.4%, which verifies the effectiveness of the present disclosure. An average of 500 calculation results of the lubrication film thicknesses is taken as a lubrication film thickness measurement result. The lubrication film thickness measurement result is compared with a theoretical solution at room temperature. At the room temperature, FIGS. 8a-8b show comparison results between measurement results and theoretical solutions at different rotational speeds and different discharge pressures. It can be observed that the measurement results and the theoretical results show good agreement at all measurement points, demonstrating the accuracy of the measurement results.

In summary, the ultrasonic method and system for simultaneously measuring coating and lubrication film thicknesses of the present disclosure utilizes the overall echo signal and the reference signal obtained by a sensor to construct the pseudo-reflection coefficient (PRC) without separating incident signals. The present disclosure decouples the lubrication film thickness and the coating thickness from the pseudo-reflection coefficient to accurately obtain the coating thickness, improving accuracy and stability of the measurement of the lubrication film thickness of the four-layer structure, which has important engineering significance for simultaneous measurement of coating and lubrication film thicknesses of the friction pair with the four-layer structure.

In can be clearly understood by those skilled in the art that for the convenience and conciseness of description, the division of the functional units and modules is merely illustrative. In practical applications, the above function can be allocated to be completed by different functional units and modules as needed, that is, an internal structure of the device is divided into different functional units or modules to complete all or part of the above functions. The functional units and modules in the embodiments can be integrated into one processing unit, or each of the functional units and modules can separately exist as an independent physical entity, or two or more functional units and modules are integrated into one unit. The integrated unit can be implemented in the form of hardware or as software functional units. In addition, specific names of the functional units and modules are only for distinguishing from each other and are not intended to limit the scope of this application defined by the appended claims. For specific working processes of the units and modules in the above system, reference can be made to corresponding processes in embodiments of the method, which is not reiterated herein.

In the above embodiments, description of each embodiment has its own focus. For parts that are not elaborated or recorded in a certain embodiment, reference can be made to relevant descriptions in other embodiments.

In can be understood by those skilled in the art that the units and algorithm steps in the embodiments of the present disclosure can be implemented in electronic hardware, or a combination of computer software and electronic hardware. Whether these functions are performed in hardware or software depends on the specific application and design constraints of the technical solutions. Those skilled in the art can use different methods to implement the described functions for each particular application, but such implementation should not be considered beyond the scope of this application.

In the embodiments of the present disclosure, it should be understood that the disclosed devices/terminal and method can be implemented in other manners. For example, the devices/terminal in the embodiments are only illustrative. For example, the division of modules or units is only based on logical functionality, and can be divided in other manners in practical implementation. For example, multiple units or components can be combined or integrated into another system, or some features can be omitted or not executed. Besides, mutual couplings, direct couplings or communication connections shown or discussed can be indirectly coupled or communicated through some interfaces, apparatuses, or units, in the form of electrical, mechanical, or in other forms.

The units as separate components can be physically separated or not, and the components displayed as units can be physical units or not, that is, the components can be located in one place, or distributed across multiple network units. Some or all of these units can be selected according to actual needs to achieve the objects of the embodiments.

In addition, the functional units in the various embodiments of the present disclosure can be integrated into one processing unit, or each unit can exist as a separate physical entity, or two or more units can be integrated into one unit. The integrated units can be implemented in the form of hardware or software functional units.

The integrated modules/units, if implemented in the form of software functional units and sold or used as independent products, can be stored in a computer-readable storage medium. Based on this understanding, all or part of the processes in the embodiments of the method of the present disclosure can be completed via corresponding hardware instructed by the computer program. The computer program can be stored in the computer-readable storage medium. When the computer program is executed by the processor, the steps in the embodiments of the method can be realized. In an embodiment, the computer program includes computer program code, which can be the form of source code, object code, an executable file, or certain intermediate forms. The computer-readable medium may include any entity or device, recording medium, USB flash drive, removable hard disk, magnetic disk, optical disk, computer memory, read-only memory (ROM), random access memory (RAM), electrical carrier signals, telecommunications signals, and software distribution media that can carry the computer program code. It should be noted that the content included in the computer-readable medium can be appropriately increased or decreased according to the requirements of legislation and patent practice in a judicial jurisdiction. For example, in some jurisdictions, under legislation and patent practice, the computer-readable storage medium does not include electrical carrier signals and telecommunications signals.

This application is described with reference to flowcharts and/or block diagrams of methods, devices (systems), and computer program products according to embodiments of the present disclosure. It should be understood that each process and/or block in the flowcharts and/or block diagrams, and a combination thereof can be implemented by computer program instructions. These computer program instructions can be provided to a general-purpose computer, a dedicated computer, an embedded processor, or other programmable data processing devices to configure a machine. This machine, when operated by the computer or other programmable data processing devices, produces an apparatus that performs the functions specified in one or more processes of the flowchart and/or one or more blocks of the block diagram.

These computer program instructions can also be stored in a computer-readable storage medium that can be used to configure a computer or other programmable data processing device to operate in a specific manner. The instructions stored in the computer-readable storage medium produce an article of manufacture that includes the instructions, and implements the functions specified in one or more processes of the flowchart and/or one or more blocks of the block diagram.

The computer program instructions can also be loaded onto a computer or other programmable data processing devices, causing the computer or other programmable devices to execute a series of operational steps to produce a machine-implemented process. As a result, the instructions executed by the computer or other programmable devices provide steps for performing the functions specified in one or more processes of the flowchart and/or one or more blocks of the block diagram.

Described above are only for illustrating the technical ideas of the present disclosure, which is not intended to limit the scope of this application. Any modification made on the basis of the technical solutions according to the technical ideas of the present disclosure shall fall within the scope of this application defined by the appended claims.

What is claimed is:

1. An ultrasonic method for simultaneously measuring coating and lubrication film thicknesses of a friction pair in real time, the friction pair having a four-layer structure consisting of a first solid layer, a coating, a lubrication film and a second solid layer from inside to outside, and the ultrasonic method comprising:
deploying an ultrasonic sensor at the first solid layer;
constructing a pseudo-reflection coefficient;
obtaining an amplitude spectrum of the pseudo-reflection coefficient;
if there is an extremum point in the amplitude spectrum of the pseudo-reflection coefficient, extracting a first pseudo-reflection coefficient information corresponding to an ultrasonic frequency at the extremum point to obtain a coating thickness d, and obtaining a first thickness h₁ of the lubrication film based on the ultrasonic frequency at the extremum point;
if there are no extremum points in the amplitude spectrum of the pseudo-reflection coefficient, extracting a second pseudo-reflection coefficient information corresponding to an ultrasonic frequency at a maximum of an amplitude spectrum of a reference signal to obtain a second thickness h₂ of the lubrication film; and
based on the first thickness h₁ and the second thickness h₂, measuring a thickness h of the lubrication film over a range of the friction pair in real time.

2. The ultrasonic method of claim 1, wherein the step of constructing the pseudo-reflection coefficient comprises:
before testing, removing a lubricating medium from the four-layer structure; emitting an ultrasonic wave to a solid-coating-air-solid structure; and collecting and storing a combination of an echo signal reflected from a coating-air interface and an echo signal reflected from a solid-coating-air interface as a reference signal R(f);
during the testing, injecting the lubricating medium into the solid-coating-air structure to form the lubrication film, so as to construct the four-layer structure; continuously emitting the ultrasonic wave to the four-layer structure; and collecting and storing a combination of an echo signal reflected from a solid-coating interface, an echo signal reflected from a solid-coating-lubrication film interface and an echo signal reflected from a solid-coating-lubrication film-solid interface as an overall echo signal O(f); and
performing fast Fourier transform (FFT) on the reference signal R(f) and the overall echo signal O(f) to obtain an amplitude spectrum and a phase spectrum of the reference signal R(f), and an amplitude spectrum and a phase spectrum of the overall echo signal O(f); constructing the pseudo-reflection coefficient V_{P}(f) based on the reference signal R(f) and the overall echo signal O(f); and obtaining an amplitude spectrum |V_{P}(f)| of the pseudo-reflection coefficient V_{P}(f) and a phase spectrum Φ_{V}_{_{P}}(f) of the pseudo-reflection coefficient V_{P}(f).

3. The ultrasonic method of claim 2, wherein the pseudo-reflection coefficient V_{P}(f) is expressed as:
$${V}_{P} ( f ) = \frac{O ( f )}{R ( f )} .$$

4. The ultrasonic method of claim 1, wherein the first thickness h₁ of the lubrication film is expressed as:
$${h}_{1} = \frac{{c}_{3}}{2 {f}_{r}} ,$$
wherein c₃ represents a sound velocity in the lubrication film; and fᵣ represents a first-order resonance frequency in the amplitude spectrum of the pseudo-reflection coefficient.

5. The ultrasonic method of claim 4, wherein the coating thickness d is expressed as:
$$d = \frac{{c}_{2}}{4 π {f}_{r}} Arg [ \frac{\sqrt{4 ( {T}_{R}^{6} {T}_{R}^{8} {V}_{P} ( {f}_{r} ) - {τ}_{R}^{2} {τ}_{R}^{4} ) ( {T}_{R}^{1} - {T}_{R}^{5} {T}_{R}^{7} {V}_{P} ( {f}_{r} ) ) + {( {T}_{R}^{2} + {T}_{R}^{1} {T}_{R}^{4} - ( {T}_{R}^{6} {T}_{R}^{7} + {T}_{R}^{5} {T}_{R}^{8} ) {V}_{P} ( {f}_{r} ) )}^{2}}}{2 {T}_{R}^{2} {T}_{R}^{4} - 2 {T}_{R}^{6} {T}_{R}^{8} {V}_{P} ( {f}_{r} )} + \frac{( {T}_{R}^{6} {T}_{R}^{7} + {T}_{R}^{5} {T}_{R}^{8} ) {V}_{P} ( {f}_{r} ) - {T}_{R}^{2} - {T}_{R}^{1} {T}_{R}^{4}}{2 {T}_{R}^{2} {T}_{R}^{4} - 2 {T}_{R}^{6} {T}_{R}^{8} {V}_{P} ( {f}_{r} )}$$
$$\{ \begin{matrix}{T}_{R}^{1} = {z}_{1} {z}_{2} - {z}_{2}^{2} + {z}_{1} {z}_{4} - {z}_{2} {z}_{4} \\ {T}_{R}^{2} = {z}_{1} {z}_{2} + {z}_{2}^{2} - {z}_{1} {z}_{4} - {z}_{2} {z}_{4} \\ {T}_{R}^{3} = {z}_{1} {z}_{2} + {z}_{2}^{2} + {z}_{1} {z}_{air} + {z}_{2} {z}_{air} \\ {T}_{R}^{4} = {z}_{1} {z}_{2} - {z}_{2}^{2} - {z}_{1} {z}_{air} + {z}_{2} {z}_{air} \\ {T}_{R}^{5} = {z}_{1} {z}_{2} + {z}_{2}^{2} + {z}_{1} {z}_{4} + {z}_{2} {z}_{4} \\ {T}_{R}^{6} = {z}_{1} {z}_{2} - {z}_{2}^{2} - {z}_{1} {z}_{4} + {z}_{2} {z}_{4} \\ {T}_{R}^{7} = {z}_{1} {z}_{2} - {z}_{2}^{2} + {z}_{1} {z}_{air} - {z}_{2} {z}_{air} \\ {T}_{R}^{8} = {z}_{1} {z}_{2} + {z}_{2}^{2} - {z}_{1} {z}_{air} - {z}_{2} {z}_{air}\end{matrix} ;$$
wherein V_{P}(fᵣ) represents a pseudo-reflection coefficient corresponding to an ultrasonic frequency fᵣ of the extremum point; zᵢ represents an acoustic impedance of an i-th medium, wherein i=1, 2, 4; ρᵢ represents a density of the i-th medium; cᵢ represents a sound velocity in the i-th medium; zₐᵢᵣ represents an acoustic impedance of air; and
$${T}_{R}^{i}$$
represents a transform symbol, wherein i=1, 2, . . . , 8.

6. The ultrasonic method of claim 1, wherein the second thickness h₂ of the lubrication film is expressed as:
$${h}_{2} = \frac{{c}_{3}}{4 π {f}_{c}} arg [ \frac{( {z}_{3} + {z}_{4} ) ( {z}_{3} - {z}_{3}^{eqv} )}{( {z}_{3} - {z}_{4} ) ( {z}_{3} + {z}_{3}^{eqv} )} ] ;$$
wherein f_{c} represents the ultrasonic frequency at the maximum of the amplitude spectrum of the reference signal; z₃ represents an acoustic impedance of the lubrication film; z₄ represents an acoustic impedance of the second solid layer; ρᵢ represents a density of the i-th medium; cᵢ represents a sound velocity in the i-th medium;
$${z}_{i}^{eqv}$$
represents an equivalent impedance of the i-th medium in a solid-coating-lubrication film-solid structure.

7. The ultrasonic method of claim 6, wherein
$${z}_{3}^{eqv}$$
is expressed as:
$${z}_{3}^{eqv} = {z}_{2} \frac{{z}_{2}^{eqv} - {z}_{2} + ( {z}_{2}^{eqv} + {z}_{2} ) {e}^{i 2 {k}_{2} d}}{{z}_{2} - {z}_{2}^{eqv} + ( {z}_{2}^{eqv} + {z}_{2} ) {e}^{i 2 {k}_{2} d}} .$$
wherein
$${z}_{2}^{eqv}$$
represents an equivalent impedance of a coating in the solid-coating-lubrication film-solid structure; z₂ represents an acoustic impedance of the coating; ρ₂ represents a density of the coating; c₂ represents a sound velocity in the coating; k₂ represents a wave number of the coating; and d represents the coating thickness.

8. The ultrasonic method of claim 7, wherein the equivalent impedance
$${z}_{2}^{eqv}$$
of the coating is expressed as:
$${z}_{2}^{eqv} = {z}_{1} \frac{{z}_{1} + {z}_{2}^{{eqv}^{′}} + ( {z}_{2}^{{eqv}^{′}} - {z}_{1} ) {V}_{P} ( {f}_{c} )}{{z}_{1} + {z}_{2}^{{eqv}^{′}} - ( {z}_{2}^{{eqv}^{′}} - {z}_{1} ) {V}_{P} ( {f}_{c} )} ;$$
wherein z₁ represents an acoustic impedance of the first solid layer; ρ₁ represents a density of the first solid layer; c₁ represents a sound velocity of the first solid layer;
$${z}_{2}^{{eqv}^{′}}$$
represents an equivalent impedance of the coating in the solid-coating-air structure; and V_{P}(f_{c}) represents a pseudo-reflection coefficient corresponding to the ultrasonic frequency f_{c}.

9. The ultrasonic method of claim 8, wherein
$${z}_{2}^{{eqv}^{′}}$$
is expressed as:
$${z}_{2}^{{eqv}^{′}} = {z}_{2} \frac{( {z}_{air}^{eqv} + {z}_{2} ) {e}^{- {ik}_{2} d} + ( {z}_{air}^{eqv} - {z}_{2} ) {e}^{{ik}_{2} d}}{( {z}_{air}^{eqv} + {z}_{2} ) {e}^{- {ik}_{2} d} - ( {z}_{air}^{eqv} - {z}_{2} ) {e}^{{ik}_{2} d}} ;$$
wherein
$${z}_{air}^{eqv}$$
represents an equivalent impedance of air in the solid-coating-air structure.

10. An ultrasonic system for simultaneously measuring coating and lubrication film thicknesses of a friction pair, the friction pair having a four-layer structure, and the ultrasonic system comprising:
a construction module;
a judgement module; and
a measurement module;
wherein the construction module is configured to construct a pseudo-reflection coefficient;
the judgement module is configured to perform:
obtaining an amplitude spectrum of the pseudo-reflection coefficient; and
determining whether there is an extremum point in the amplitude spectrum of the pseudo-reflection coefficient; if yes, extracting a first pseudo-reflection coefficient information corresponding to an ultrasonic frequency at the extremum point to obtain a coating thickness d, and obtaining a first thickness h₁ of a lubrication film; otherwise, extracting a second pseudo-reflection coefficient information corresponding to an ultrasonic frequency at a maximum of an amplitude spectrum of a reference signal to obtain a second thickness h₂ of the lubrication film; and
the measurement module is configured to measure a thickness h of the lubrication film over a range of the four-layer structure based on the first thickness h₁ and the second thickness h₂.
